(19) United States
(12) Patent Application Publication
(10) Pub. No.: US 2010/0261012 A1
(43) Pub. Date: Oct. 14, 2010

(54) Flexible Display Panel and Method of Manufacturing the same

(76) Inventors: Jen-Shiun Huang, Hsinchu (TW); Chun-Nan Yeh, Hsinchu (TW); Wen-Hsin Lu, Hsinchu (TW)

Correspondence Address: LanWay IPR Services, P.O. Box 220746, Chantilly, VA, 20153, US

(21) Appl. No.: 12/421,939

(22) Filed: Apr. 10, 2009

(51) Int. Cl. B32B 27/06; B05D 5/12

(52) U.S. Cl. 428/337; 428/473.5; 428/332; 427/58

(57) ABSTRACT

A flexible display panel includes a flexible display module and a cured protection layer. The flexible display module includes a flexible substrate, a first circuit layer, a display layer and a second circuit layer. The flexible substrate has a first surface and a second surface opposite to the first surface. The first circuit layer is disposed on the first surface and has a view area. The display layer is disposed on the first circuit layer and corresponding to the view area. The second circuit layer is disposed on the display layer. The cured protection layer is disposed on the second surface. The inner circuit of the flexible display panel is protected by the cured protection layer. In addition, a method of manufacturing the flexible display panel is also provided.

### BACKGROUND

This application claims priority to the Taiwan application No. 098105157 filed on Feb. 18, 2009.

1. Field of the Invention

The present invention relates generally to a display panel and a method of manufacturing the same. More particularly, the present invention relates to a flexible display panel and a method of manufacturing the same.

2. Detailed Description of the Related Art

FIG. 1 is a schematic cross-section view of a conventional flexible display panel. Please referring to FIG. 1, the conventional flexible display panel 100 includes a flexible display module 110, a plurality of flexible circuit boards 120 and a plurality of drivers 130. The flexible display module 110 includes a flexible substrate 111, a first circuit layer 112, an electrophoretic layer 113, a second circuit layer 114 and an insulation attachment layer 115.

The flexible substrate 111 has a first surface 111a and a second surface 111b opposite to each other. The insulation attachment layer 115 is disposed on the first surface 111a of the flexible substrate 111. The first circuit layer 112 is disposed on the insulation attachment layer 115. The first circuit layer 112 has a view area 112a and a peripheral circuit area 112b. The first circuit layer 112 includes a plurality of pixel electrodes 112c arranged in an array and a plurality of thin film transistors (TFTs) (not shown) corresponding to the pixel electrodes 112c, respectively. The pixel electrodes 112c and the TFTs are located in the view area 112a. In addition, the TFTs are attached to the flexible substrate 111 through the insulation attachment layer 115.

The electrophoretic layer 113 is disposed on the first circuit layer 112 and corresponding to the view area 112a. The electrophoretic layer 113 has a plurality of microcapsules 113a and the electrophoretic fluid 113b filling each of the microcapsules 113a. The electrophoretic fluid 113b in each of the microcapsules 113a includes the dielectric solvent 113c and a plurality of electropheretic particles 113d. The electrophoretic particles 113d in each of the microcapsules 113a are dispersed in the corresponding dielectric solvent 113c.

The second circuit layer 114 is disposed on the electrophoretic layer 113. The second circuit layer 114 is a transparent conductive thin film composed of Indium-Tin-Oxide (ITO). In other words, the second circuit layer 114 is a common ITO electrode. The flexible circuit boards 120 are electrically connected to the peripheral circuit area 112b through a first anisotropic conductive film (ACF) A1. Each of the drivers 130 is an integrated circuit chip (IC chip). The drivers 130 are electrically connected to the peripheral circuit area 112b through a second ACF A2.

However, because the thickness t1 of the flexible substrate 111 is relatively thin and the thickness t1 is usually between 0 and 20 micrometers, the first circuit layer 112 is easily damaged when the second surface 111b of the flexible substrate 111 is under pressure F1.

### BRIEF SUMMARY

The present invention is directed to provide a flexible display panel which has a cured protection layer for protecting inner circuit of the flexible display panel.

The present invention is also directed to provide a method of manufacturing a flexible display module. A cured protection layer is formed through the method for protecting inner circuit of the flexible display panel.

The present invention provides a flexible display panel including a flexible display module and a cured protection layer. The flexible display module includes a flexible substrate, a first circuit layer, a display layer and a second circuit layer. The flexible substrate has a first surface and a second surface opposite to each other. The first circuit layer is disposed on the first surface and has a view area. The display layer is disposed on the first circuit layer and corresponding to the view area. The second circuit layer is disposed on the display layer. The cured protection layer is disposed on the second surface.

In one embodiment of the present invention, the cured protection layer is composed of ultraviolet cured adhesive or heat cured adhesive.

In one embodiment of the present invention, the thickness of the cured protection layer is between 0 and 0.2 millimeters.

In one embodiment of the present invention, the thickness of the flexible substrate is between 0 and 20 micrometers.

In one embodiment of the present invention, the flexible substrate is composed of polyimide (PI).

The present invention provides a method of manufacturing a flexible display panel including the following steps. First, a supporting substrate is provided. Next, a flexible display module is formed on the supporting substrate. The flexible display module includes a flexible substrate, a first circuit layer, a display layer and a second circuit layer. The flexible substrate is disposed on the supporting substrate and has a first surface and a second surface opposite to each other. The second surface faces the supporting substrate. The first circuit layer is disposed on the first surface and has a view area. The display layer is disposed on the first circuit layer and corresponding to the view area. The second circuit layer is disposed on the display layer. Next, the supporting substrate is removed. Afterwards, a protection material layer is formed on the second surface. The protection material layer is colloidal. Afterwards, the protection material layer is cured to form a cured protection layer.

In one embodiment of the present invention, the protection material layer is cured by means of irradiating the protection material layer with ultraviolet or heating the protection material layer.

In one embodiment of the present invention, the thickness of the cured protection layer is between 0 and 0.2 millimeters.

In one embodiment of the present invention, the thickness of the flexible substrate is between 0 and 20 micrometers.

In one embodiment of the present invention, the protection material layer is formed on second surface by means of coating, spraying or screen printing.

Because the cured protection layer is disposed on the second surface of the flexible substrate, the cured protection layer protects the second surface of the flexible substrate. Accordingly, when a pressure is exerted on the cured protection layer, the first circuit layer of the flexible display module is hardly damaged. In other words, the inner circuit of the flexible display panel of the embodiment of the present invention is protected by the cured protection layer.

### BRIEF DESCRIPTION OF THE DRAWINGS

The accompanying drawings are included to provide a further understanding of the invention, and are incorporated in and constitute part of this specification. The drawings illustrate embodiments of the invention and, together with the description, serve to explain the principles of the invention.

FIG. 1 is a schematic cross-section view of a conventional flexible display panel.

FIG. 2 is a schematic cross-section view of a flexible display panel of an embodiment of the present invention.

FIGS. 3A to 3F are schematic views of manufacturing the flexible display panel of FIG. 2.

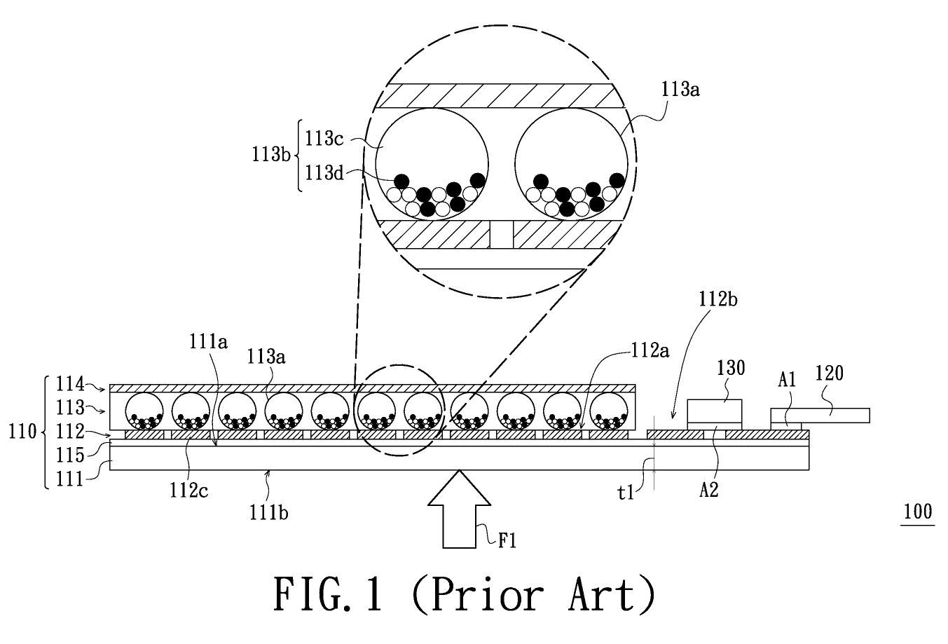

### DETAILED DESCRIPTION

Reference will now be made to the drawings to describe exemplary embodiments of the present display method, in detail. The following description is given by way of example, and not limitation.

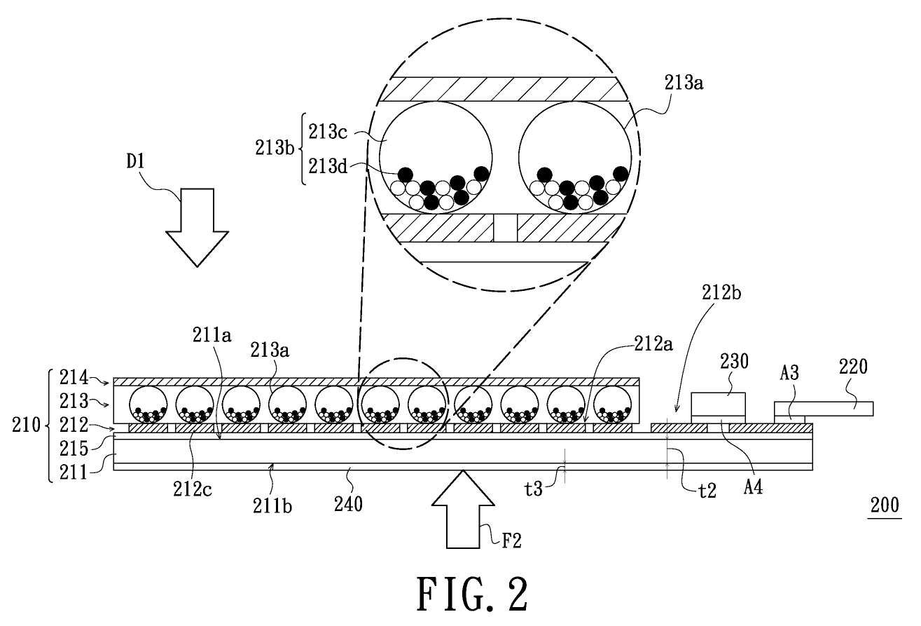

FIG. 2 is a schematic cross-section view of a flexible display panel of an embodiment of the present invention. Please referring to FIG. 2, the flexible display panel 200 of the present embodiment includes a flexible display module 210, a plurality of flexible circuit boards 220 (one of the flexible circuit boards 220 is schematically shown in FIG. 2), a plurality of drivers 230 (one of the drivers 230 is schematically shown in FIG. 2) and a cured protection layer 240. The flexible display module 210 includes a flexible substrate 211, a first circuit layer 212, a display layer 213, a second circuit layer 214 and an insulation attachment layer 215.

The flexible substrate 211 has a first surface 211a and a second surface 211b opposite to each other. The flexible substrate 211 is composed of polyimide (PI) and the thickness t2 of the flexible substrate 211 is between 0 and 20 micrometers. The insulation attachment layer 215 is disposed on the first surface 211a of the flexible substrate 211. The first circuit layer 212 is disposed on the insulation attachment layer 215. The first circuit layer 212 has a view area 212a and a peripheral circuit area 212b. The first circuit layer 212 includes a plurality of pixel electrodes 212c arranged in an array and a plurality of TFTs (not shown) corresponding to the pixel electrodes 212c, respectively. The electrode pixels 212c and the TFTs are located in the view area 212a. In addition, the TFTs are attached to the flexible substrate 211 through the insulation attachment layer 215.

The display layer 213 such as an electrophoretic layer is disposed on the first circuit layer 212 and corresponding to the view area 212a. The display layer 213 such as the electrophoretic layer has a plurality of microcapsules 213a and the electrophoretic fluid 213b filling each of the microcapsules 213a. The electrophoretic fluid 213b in each of the microcapsules 213a includes the dielectric solvent 213c and a plurality of electrophoretic particles 213d. The electrophoretic particles 213d in each of the microcapsules 213a are dispersed in the corresponding dielectric solvent 213c. In the present embodiment, the electrophoretic particles 213d in each of the microcapsules 213a may be the combination of black electrophoretic particles and white electrophoretic particles. In addition, a plurality of microcups may be substituted for the microcapsules 213a of the present embodiment. The scope of the present invention is not limited herein.

The second circuit layer 214 is disposed on the display layer 213. The second circuit layer 214 is a transparent conductive thin film composed of ITO. In other words, the second circuit layer 214 is a common ITO electrode. In another embodiment, the first circuit layer 212 may include a plurality of ITO electrodes parallel to each other in the view area 212a. The second circuit layer 214 may include a plurality of ITO electrodes parallel to each other. The direction of arrangement of the ITO electrodes of the first circuit layer 212 is perpendicular to that of arrangement of the ITO electrodes of the second circuit layer 214. However, the above is not shown in the drawings.

The flexible circuit boards 220 are electrically connected to the peripheral circuit area 212b through a first ACF A3. Each of the drivers 230 is an IC chip. The drivers 230 are electrically connected to the peripheral circuit area 212b through a second ACF A4. It should be noted that in another embodiment, the drivers 230 are disposed on the flexible circuit boards 220 respectively according to the designer's requirement.

The cured protection layer 240 is disposed on the second surface 211b of the flexible substrate 211. The cured protection layer 240 is composed of ultraviolet cured adhesive or heat cured adhesive. The thickness t3 of the cured protection layer 240 is between 0 and 0.2 millimeters. Because the cured protection layer 240 is disposed on the second surface 211b of the flexible substrate 211, the cured protection layer 240 protects the second surface 211b of the flexible substrate 211. Accordingly, when a pressure F2 is exerted on the cured protection layer 240, the first circuit layer 212 is hardly damaged.

When the flexible display panel 200 of the present embodiment operates, the electrical field in each of the microcapsules 213a is generated between the first circuit layer 212 and the second circuit layer 214 and specific. At this time, part of the electrophoretic particles 213d in each of the microcapsules 213a move to the second circuit layer 214 to display a kind of information. Accordingly, a user can look at the flexible display module 210 of the flexible display panel 200 in the viewing direction D1 shown in FIG. 2 to read the information displayed.

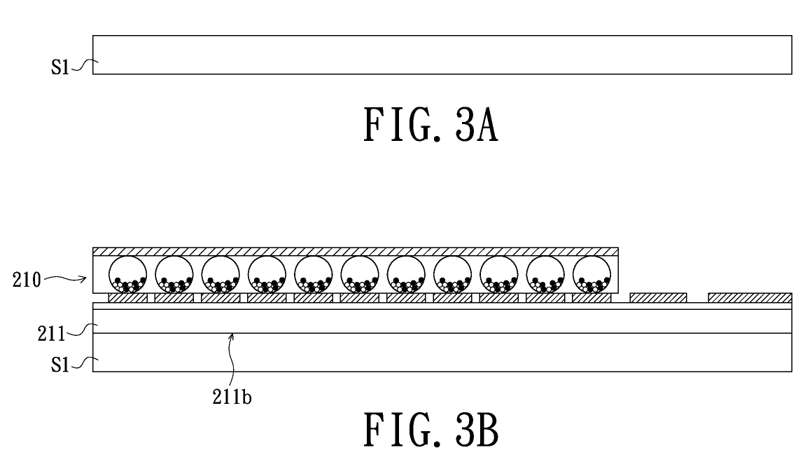

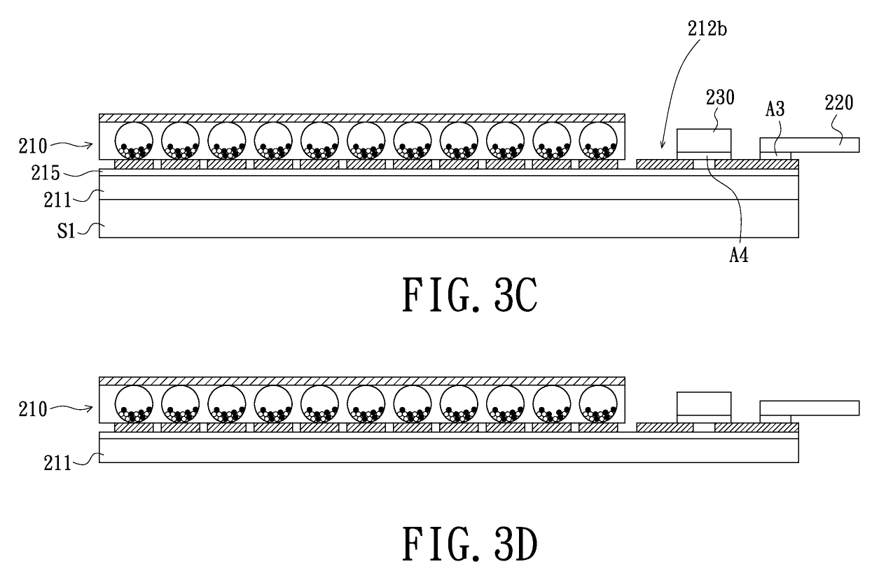

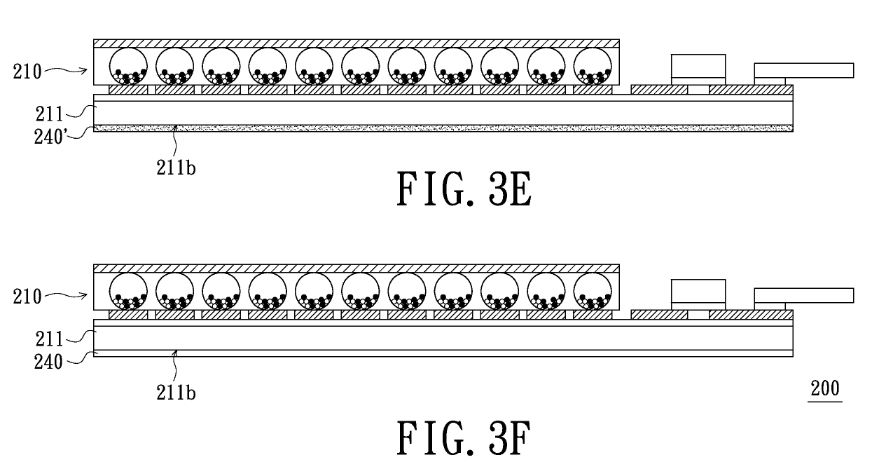

A method of manufacturing the flexible display panel 200 of the present embodiment is described below. FIGS. 3A to 3F are schematic views of manufacturing the flexible display panel of FIG. 2. First, please referring FIG. 3A, a supporting substrate S1 which may be composed of glass is provided. Next, please referring FIG. 3B, a flexible display module 210 is formed on the supporting substrate S1. The flexible substrate 211 of the flexible display module 210 is disposed on the supporting substrate S1. The second surface 211b of the flexible substrate 211 faces the supporting substrate S1.

Next, please referring FIG. 3C, the flexible circuit boards 220 are thermocompressively bonded to the peripheral circuit area 212b through the first ACF A3 to electrically connect each of the flexible circuit boards 220 and the peripheral circuit area 212b. Next, the drivers 230 are thermocompressively bonded to the peripheral circuit area 212b through the second ACF A4 to electrically connect each of the drivers 230 and the peripheral circuit area 212b. Afterwards, please referring to FIGS. 3C and 3D, the supporting substrate S1 is removed.

Afterwards, please referring to FIG. 3E, a protection material layer 240′ is formed on the second surface 211b of the flexible substrate 211. At this time, the protection material layer 240′ is colloidal. In the present embodiment, the protection material layer 240′ is formed on second surface 211b of the flexible substrate 211 by means of coating, spraying or screen printing.

Afterwards, please referring to FIGS. 3E and 3F, the protection material layer 240′ is cured to form the cured protection layer 240. The flexible display panel 200 is completed according to the above steps. It should be noted that the protection material layer 240′ is cured by means of irradiating the protection material layer 240′ with ultraviolet if the protection material layer 240′ is composed of ultraviolet cured adhesive. The protection material layer 240′ is cured by means of heating the protection material layer 240′ if the protection material layer 240′ is composed of heat cured adhesive.

Because the protection material layer 240′ is colloidal, the pressure exerted on the second surface 211b of the flexible substrate 211 can be controlled in the range of what the flexible substrate 211 can bear when the protection material layer 240′ is formed on the second surface 211b of the flexible substrate 211. In addition, the protection material layer 240′ of the present embodiment is formed on second surface 211b of the flexible substrate 211 by means of coating, spraying or screen printing, so the pressure exerted on the second surface 211b of the flexible substrate 211 can also be controlled in the range of what the flexible substrate 211 can bear when the protection material layer 240′ is formed on the second surface 211b of the flexible substrate 211.

To sum up, the flexible display panel of the embodiment of the present invention and the method of manufacturing the same at least has one of the following advantages or other advantages:

1. Because the cured protection layer is disposed on the second surface of the flexible substrate, the cured protection layer protects the second surface of the flexible substrate. Accordingly, when a pressure is exerted on the cured protection layer, the first circuit layer of the flexible display module is hardly damaged. In other words, the inner circuit of the flexible display panel is protected by the cured protection layer.

2. Because the protection material layer is colloidal, the pressure exerted on the second surface of the flexible substrate can be controlled in the range of what the flexible substrate can bear when the protection material layer is formed on the second surface of the flexible substrate.

3. The protection material layer is formed by means of coating, spraying or screen printing, so the pressure exerted on the second surface of the flexible substrate can also be controlled in the range of what the flexible substrate can bear.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A flexible display panel comprising:
a flexible display module comprising;
a flexible substrate having a first surface and a second surface opposite to each other;
a first circuit layer disposed on the first surface and having a view area;
a display layer disposed on the first circuit layer and corresponding to the view area; and
a second circuit layer disposed on the display layer; and
a cured protection layer disposed on the second surface.

2. The flexible display panel as claimed in claim 1, wherein the cured protection layer is composed of ultraviolet cured adhesive or heat cured adhesive.

3. The flexible display panel as claimed in claim 1, wherein the thickness of the cured protection layer is between 0 and 0.2 millimeters.

4. The flexible display panel as claimed in claim 1, wherein the thickness of the flexible substrate is between 0 and 20 micrometers.

5. The flexible display panel as claimed in claim 1, wherein the flexible substrate is composed of polyimide.

6. A method of manufacturing a flexible display panel, comprising:
providing a supporting substrate;
forming a flexible display module on the supporting substrate, wherein the flexible display module comprises:
a flexible substrate disposed on the supporting substrate and having a first surface and a second surface opposite to each other, wherein the second surface faces the supporting substrate;
a first circuit layer disposed on the first surface and having a view area;
a display layer disposed on the first circuit layer and corresponding to the view area; and
a second circuit layer disposed on the display layer;
removing the supporting substrate; and
forming a protection material layer on the second surface, wherein the protection material layer is colloidal; and
curing the protection material layer to form a cured protection layer.

7. The method of manufacturing the flexible display panel as claimed in claim 6, wherein the protection material layer is cured by means of irradiating the protection material layer with ultraviolet or heating the protection material layer.

8. The method of manufacturing the flexible display panel as claimed in claim 6, wherein the thickness of the cured protection layer is between 0 and 0.2 millimeters.

9. The method of manufacturing the flexible display panel as claimed in claim 6, wherein the thickness of the flexible substrate is between 0 and 20 micrometers.

10. The method of manufacturing the flexible display panel as claimed in claim 6, wherein the protection material layer is formed on second surface by means of coating, spraying or screen printing.
